(19) United States
(12) Patent Application Publication
(10) Pub. No.: US 2010/0285365 A1
(43) Pub. Date: Nov. 11, 2010

(54) Li-ION BATTERY WITH POROUS ANODE

(75) Inventors: Boris Kozinsky, Newton, MA (US); John F. Christensen, Mountain View, CA (US); Nalin Chaturvedi, Sunnyvale, CA (US); Jasim Ahmed, Mountain View, CA (US); Inna Kozinsky, Mountain View, CA (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: ROBERT BOSCH GMBH, Stuttgart (DE)

(21) Appl. No.: 12/437,822

(22) Filed: May 8, 2009

(51) Int. Cl. H01M 4/58

(52) U.S. Cl. 429/231.95

(57) ABSTRACT

An electrochemical cell in one embodiment includes a first electrode, and a second electrode spaced apart from the first electrode, the second electrode including a substrate of active material formed with a plurality of interconnected chambers defined by a respective one of a plurality of inwardly curving walls, and a form of lithium.

Cross-reference is made to U.S. Utility patent application Ser. No. 12/437,576 entitled “Li-ion Battery with Selective Moderating Material” by John F. Christensen et al., which was filed on May 8, 2009; U.S. Utility patent application Ser. No. 12/437,592 entitled “Li-ion Battery with Blended Electrode” by John F. Christensen et al., which was filed on May 8, 2009; U.S. Utility patent application Ser. No. 12/437,606 entitled “Li-ion Battery with Variable Volume Reservoir” by John F. Christensen et al., which was filed on May 8, 2009; U.S. Utility patent application Ser. No. 12/437,622 entitled “Li-ion Battery with Over-charge/Over-discharge Failsafe” by John F. Christensen et al., which was filed on May 8, 2009; U.S. Utility patent application Ser. No. 12/437,643 entitled “System and Method for Pressure Determination in a Li-ion Battery” by John F. Christensen et al., which was filed on May 8, 2009; U.S. Utility patent application Ser. No. 12/437,745 entitled “Li-ion Battery with Load Leveler” by John F. Christensen et al., which was filed on May 8, 2009; U.S. Utility patent application Ser. No. 12/437,774 entitled “Li-ion Battery with Anode Coating” by Boris Kozinsky et al., which was filed on May 8, 2009; U.S. Utility patent application Ser. No. 12/437,791 entitled “Li-ion Battery with Anode Expansion Area” by Boris Kozinsky et al., which was filed on May 8, 2009; U.S. Utility patent application Ser. No. [Attorney Docket No. 1576-0306] entitled “Li-ion Battery with Rigid Anode Framework” by Boris Kozinsky et al., which was filed on May 8, 2009; U.S. Utility patent application Ser. No. [Attorney Docket No. 1576-0308] entitled “System and Method for Charging and Discharging a Li-ion Battery” by Nalin Chaturvedi et al., which was filed on May 8, 2009; and U.S. Utility patent application Ser. No. [Attorney Docket No. 1576-0310] entitled “System and Method for Charging and Discharging a Li-ion Battery Pack” by Nalin Chaturvedi et al., which was filed on May 8, 2009, the entirety of each of which is incorporated herein by reference. The principles of the present invention may be combined with features disclosed in those patent applications.

### FIELD OF THE INVENTION

This invention relates to batteries and more particularly to lithium-ion batteries.

### BACKGROUND

Batteries are a useful source of stored energy that can be incorporated into a number of systems. Rechargeable lithium-ion batteries are attractive energy storage systems for portable electronics and electric and hybrid-electric vehicles because of their high specific energy compared to other electrochemical energy storage devices. In particular, batteries with a form of lithium metal incorporated into the negative electrode afford exceptionally high specific energy (in Wh/kg) and energy density (in Wh/L) compared to batteries with conventional carbonaceous negative electrodes.

When high-specific-capacity negative electrodes such as lithium are used in a battery, the maximum benefit of the capacity increase over conventional systems is realized when a high-capacity positive electrode active material is also used. Conventional lithium-intercalating oxides (e.g., LiCoO₂, LiNiO_{0.8}CoO_{0.15}Al_{0.05}O₂, Li_{1.1}Ni_{0.3}Co_{0.3}Mn_{0.3}O₂) are typically limited to a theoretical capacity of ˜280 mAh/g (based on the mass of the lithiated oxide) and a practical capacity of 180 to 250 mAh/g. In comparison, the specific capacity of lithium metal is about 3863 mAh/g. The highest theoretical capacity achievable for a lithium-ion positive electrode is 1168 mAh/g (based on the mass of the lithiated material), which is shared by Li₂S and Li₂O₂. Other high-capacity materials including BiF₃ (303 mAh/g, lithiated) and FeF₃ (712 mAh/g, lithiated) are identified in Amatucci, G. G. and N. Pereira, Fluoride based electrode materials for advanced energy storage devices. Journal of Fluorine Chemistry, 2007. 128(4): p. 243-262. All of the foregoing materials, however, react with lithium at a lower voltage compared to conventional oxide positive electrodes, hence limiting the theoretical specific energy. The theoretical specific energies of the foregoing materials, however, are very high (>800 Wh/kg, compared to a maximum of ˜500 Wh/kg for a cell with lithium negative and conventional oxide positive electrodes).

Lithium/sulfur (Li/S) batteries are particularly attractive because of the balance between high specific energy (i.e., >350 Wh/kg has been demonstrated), rate capability, and cycle life (>50 cycles). Only lithium/air batteries have a higher theoretical specific energy. Lithium/air batteries, however, have very limited rechargeability and are still considered primary batteries.

Li/S batteries also have limitations. By way of example, the United States Advanced Battery Consortium has established a goal of >1000 cycles for batteries used in powering an electric vehicle. Li/S batteries, however, exhibit relatively high capacity fade, thereby limiting the useful lifespan of Li/S batteries.

One mechanism which may contribute to capacity fade of Li/S batteries is the manner in which the sulfur reacts with lithium. In general, sulfur reacts with lithium ions during battery discharge to form polysulfides (LiₓS), which may be soluble in the electrolyte. These polysulfides react further with lithium (i.e., the value of x increases from ¼ to ⅓ to ½ to 1) until Li₂S₂ is formed, which reacts rapidly to form Li₂S. In Li/S batteries described in the literature, both Li₂S₂ and Li₂S are generally insoluble in the electrolyte. Hence, in a system in which intermediate polysulfides are soluble, each complete cycle consists of soluble-solid phase changes, which may impact the integrity of the composite electrode structure.

Specifically, Li₂S may deposit preferentially near the separator when the current through the depth of the positive electrode is non-uniform. Non-uniformity is particularly problematic at high discharge rates. Any such preferential deposition can block pores of the electrode, putting stress on the electronically conducting matrix and/or isolating an area from the composite electrode. All of these processes may lead to capacity fade or impedance rise in the battery.

Moreover, soluble polysulfides are mobile in the electrolyte and, depending on the type of separator that is used, may diffuse to the negative electrode where the soluble polysulfides may becoming more lithiated through reactions with the lithium electrode. The lithiated polysulfide may then diffuse back through the separator to the positive electrode where some of the lithium is passed to less lithiated polysulfides. This overall shuttle process of lithium from the negative electrode to the positive electrode by polysulfides is a mechanism of self discharge which reduces the cycling efficiency of the battery and which may lead to permanent capacity loss.

Some attempts to mitigate capacity fade of Li/S batteries rely upon immobilization of the sulfur in the positive electrode via a polymer encapsulation or the use of a high-molecular weight solvent system in which polysulfides do not dissolve. In these batteries, the phase change and self-discharge characteristics inherent in the above-described Li/S system are eliminated. These systems have a higher demonstrated cycle life at the expense of high rate capability and capacity utilization.

Lithium in lithium ion batteries is also lost due to the formation of passivation layers on electrode materials. During the initial cycling of a cell, some of the lithium in the cell reacts with various cell components, e.g., electrolyte additives, to form a layer of material that is somewhat brittle and which exhibits low flexibility. The reaction creating this solid-electrolyte interface (SEI) is usually non-reversible. Accordingly, lithium consumed in forming passivation layers is no longer available for use in charging or discharging the cell. Various attempts to mitigate the loss of capacity resulting from passivation layer formation have been used. In one approach, additional lithium is charged to the cell after the formation of the passivation layers. In another approach, excess lithium is initially provided in the cell for use in forming the passivation layers.

While the above approaches may be used to mitigate the effects of passivation layer formation, they do not address the systematic loss of lithium resulting from passivation layer formation. Specifically, in the case of a Li/S battery the sulfur active material increases in volume by ˜80% as it becomes lithiated during battery discharge. During charging, the process is reversed. As noted above, the passivation layer material is relatively non-resilient and brittle. Thus, as an electrode begins to expand, the passivation layer formed on a fully charged electrode is stressed, resulting in either separation from the underlying electrode material or in cracking of the passivation layer resulting exposed electrode material.

As additional lithium ions come into contact with the exposed electrode material, new areas of passivation layer are formed. Thus, additional usable lithium is removed from the cell.

Moreover, as the electrode contracts during the next portion of the cell cycle, the passivation layer cannot contract sufficiently. Accordingly, internal stresses generate additional fracturing of the passivation layer resulting in further passivation layer material flaking away from the electrode material.

Thus, the removal of usable lithium by passivation layer formation continues over the life of the cell. Additionally, the build-up of passivation layer sediment causes reduced capacity.

What is needed therefore is a battery that provides the benefits of materials that exhibit large volume changes during operation of the cell while reducing passivation layer generation and accumulation of passivation layer sediment.

### SUMMARY

In accordance with one embodiment, an electrochemical cell includes a first electrode, and a second electrode spaced apart from the first electrode, the second electrode including a substrate with active material and formed with a plurality of interconnected chambers defined by a respective one of a plurality of inwardly curving walls, and a form of lithium.

In accordance with another embodiment, an electrochemical cell includes a first electrode, a second electrode spaced apart from the first electrode, the second electrode including a substrate with active material and formed with a plurality of interconnected chambers defined by a respective one of a plurality of inwardly curving walls, a form of lithium, and a separator layer positioned between the first electrode and the second electrode.

### BRIEF DESCRIPTION OF THE DRAWINGS

FIG. 1 depicts a schematic of a battery system including an electrochemical cell with one electrode including a material that exhibits significant volume changes as the electrochemical cell cycles, the electrode formed with a number of small interconnected chambers with inwardly curving walls; and

FIG. 2 depicts a schematic of a battery system including an electrochemical cell with one electrode including a material that exhibits significant volume changes as the electrochemical cell cycles, the electrode formed with a number of small interconnected chambers with inwardly curving walls which are more regularly shaped than the chambers of the electrochemical cell of FIG. 1.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

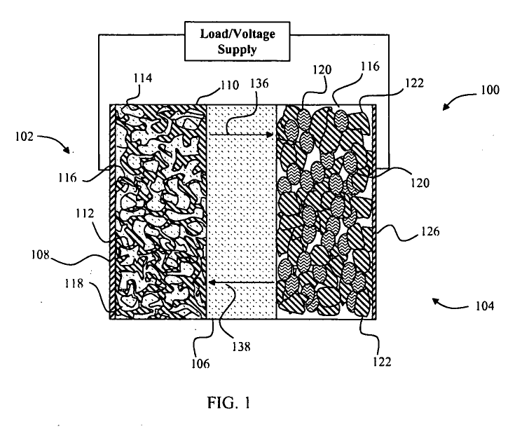

FIG. 1 depicts a lithium-ion cell 100, which includes a negative electrode 102, a positive electrode 104, and a separator region 106 between the negative electrode 102 and the positive electrode 104. The negative electrode 102 includes a current collector 108 and a substrate 110 with active material which in this embodiment is a mixture of active materials into which lithium can be inserted and inert materials. The active materials may include silicon. Alternatively, the active material may include any other element that alloys with Li, such as Sn, Al, Mg, etc.

The substrate 110 includes a number of small interconnected chambers 112 with inwardly curving walls 114. The chambers 112 are connected by passages or narrowed areas 116. In this embodiment, a fluid electrolyte 118 fills the chambers 112 and the passages 116. In alternative embodiments, a solid electrolyte may fill the chambers 112 and the passages 116 or otherwise be in contact with the substrate 110.

The separator region 106 includes an electrolyte with a lithium cation and serves as a physical and electrical barrier between the negative electrode 102 and the positive electrode 104 so that the electrodes are not electronically connected within the cell 100 while allowing transfer of lithium ions between the negative electrode 102 and the positive electrode 104.

The positive electrode 104 includes active material 120 into which lithium can be inserted, inert material 122, the electrolyte 118, and a current collector 126. The active material 120 includes a form of sulfur and may be entirely sulfur.

The lithium-ion cell 100 operates in a manner similar to the lithium-ion battery cell disclosed in U.S. patent application Ser. No. 11/477,404, filed on Jun. 28, 2006, the contents of which are herein incorporated in their entirety by reference. In general, electrons are generated at the negative electrode 102 during discharging and an equal amount of electrons are consumed at the positive electrode 104 as lithium and electrons move in the direction of the arrow 136 of FIG. 1.

In the ideal discharging of the cell 100, the electrons are generated at the negative electrode 102 because there is extraction via oxidation of lithium ions from the substrate 110 of the negative electrode 102, and the electrons are consumed at the positive electrode 104 because there is reduction of lithium ions into the active material 120 of the positive electrode 104. During discharging, the reactions are reversed, with lithium and electrons moving in the direction of the arrow 138.

As lithium is inserted into the active substrate 110, the volume of the substrate 110 increases. As the volume of the substrate 110 increases, the surface area of the chambers 112 may increase less for a given volume expansion compared to spherical particles, or may even decrease because of the inward curvature of the pore cavity walls 116. Accordingly, a passivation layer (not shown) coating the active material is not stressed as much and may even be placed into compression. Additionally, the passivation layer within the passages 114 undergoes less deformation. The predominant effect, however, is the reduced change of surface area of the passivation layer due to any volume change which is in contradistinction to the effect in prior art configurations which place the passivation layer into significant tension upon large expansion thereby exposing the underlying substrate.

Accordingly, when the volume of the substrate 110 is subsequently reduced, the stresses within the passivation layer are relaxed to the previous condition. Thus, there is little if any cracking or flaking of the passivation layer. To optimize the reduction in flaking of passivation layer material, the curvature of the inwardly curing walls 116 may be adjusted. Specifically, by increasing the “openness” of the substrate 108, the surface area within the chambers 112 is increased thereby decreasing the amount of compression placed on the passivation layer as the chamber volume decreases. The amount of compression experienced by the substrate 110 may be increased by reducing the size of the chambers 112 resulting in a more “closed” substrate 110.

The amount of surface area change corresponding to a certain amount of volume change is governed not only by the geometry of the porous structure, but also by the surface energy. Therefore, the effect described above will depend on the particular properties of the materials comprising both the electrode and the electrolyte. Thus, the surface area change of the passivation coating can be tuned by adjusting the composition of the electrolyte.

The amount of openness of a particular cell will depend upon the volume increase of the materials incorporated therein. U.S. patent application Ser. No. 11/935,721, filed on Nov. 6, 2007, the contents of which are herein incorporated in their entirety by reference, discloses a method of forming ceramic foam filters. As described therein, the “openness” of a ceramic filter may be controlled. Accordingly, a substrate 110 may be formed, for example, using the teachings of the '721 application to form a substrate 110 of the desired openness for the particular battery cell chemistry.

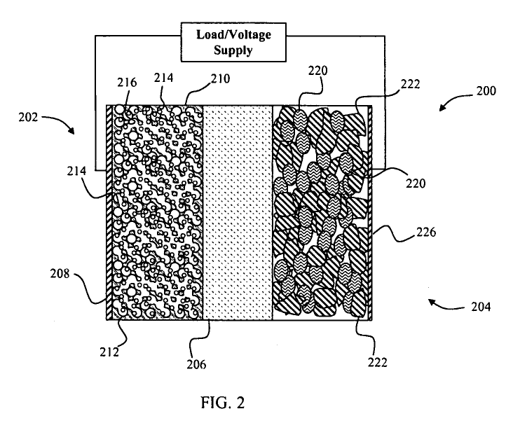

Moreover, while the chambers 112 are depicted as somewhat irregular in shape and size, the processes of the '721 application along with other processes, including semiconductor chip forming processes such as chemical etching or anodization, may be used to provide extremely small and uniformly sized chambers. By way of example, FIG. 2 depicts a lithium-ion cell 200 which includes a negative electrode 202, a positive electrode 204, and an electrolyte layer 206 between the negative electrode 202 and the positive electrode 204.

The negative electrode 202 includes a current collector 208 and a substrate 210 with active material which in this embodiment includes a form of silicon. The substrate 210 includes a number of small interconnected chambers 212 with inwardly curving walls 214. The chambers 212 are connected by passages 216.

The electrolyte layer 206 provides a transfer path for lithium ions and serves as a physical and electrical barrier between the negative electrode 202 and the positive electrode 204 so that the electrodes are not electronically connected within the cell 200. The positive electrode 204 includes active material 220 into which lithium can be inserted, inert material 222, and a current collector 226. The active material 220 includes a form of sulfur and may be entirely sulfur.

The lithium-ion cell 200 is thus similar to the lithium-ion cell 100 with the exception of the provision of an electrolyte layer 206 rather than the electrolyte 118 of FIG. 1. Additionally, the chambers 212 are more uniformly shaped and positioned as compared to the chambers 112. Accordingly, the stresses within the passivation layer formed on the substrate 210 are more uniform.

An additional feature of the lithium-ion cell 200 and the lithium-ion cell 100 is that any negative effect caused by flaking or cracking of passivation layer material is localized. Specifically, migration of the passivation layer sediment within the cells 100 and 200 is “filtered” by the restricted diameter of the passages 116 and 216. Accordingly, flaked passivation material is maintained within the particular chamber 112 or 212 that was generated the flake. Thus, passivation layer sediment build-up is contained within the chamber 112 or 212 that generated the sediment, thereby limiting the effect of sediment buildup to a local area. Moreover, the sediment build-up reduces the activity of the chamber 112 or 212 that generated the flakes, thereby reducing the rate of withdrawal of lithium within the system.

Additionally, formation of dendrites occurs within a closed space of the chamber 112 or 212. Thus, the potential for growth of dendrites into the separator layer 106 or the electrolyte layer 206 is reduced.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. An electrochemical cell, comprising:
a first electrode; and
a second electrode spaced apart from the first electrode, the second electrode including
a substrate with active material and formed with a plurality of interconnected chambers defined by a respective one of a plurality of inwardly curving walls, and
a form of lithium.

2. The electrochemical cell of claim 1, wherein the substrate comprises a ceramic foam.

3. The electrochemical cell of claim 1, wherein the substrate comprises a form of silicon.

4. The electrochemical cell of claim 3, further comprising:
an electrolyte within each of the plurality of chambers.

5. The electrochemical cell of claim 4, wherein the electrolyte is a fluid electrolyte.

6. The electrochemical cell of claim 5, wherein the first electrode is a cathode.

7. The electrochemical cell of claim 5, wherein first electrode comprises a form of sulfur.

8. An electrochemical cell, comprising:
a first electrode;
a second electrode spaced apart from the first electrode, the second electrode including
a substrate with active material and formed with a plurality of interconnected chambers defined by a respective one of a plurality of inwardly curving walls, and
a form of lithium; and
a separator layer positioned between the first electrode and the second electrode.

9. The electrochemical cell of claim 8, wherein the substrate comprises silicon.

10. The electrochemical cell of claim 9, wherein the substrate comprises a ceramic foam.

11. The electrochemical cell of claim 8, further comprising:
an electrolyte within each of the plurality of chambers.

12. The electrochemical cell of claim 11, wherein the electrolyte is a fluid electrolyte.

13. The electrochemical cell of claim 8, wherein the first electrode is a cathode.

14. The electrochemical cell of claim 13, wherein first electrode comprises a form of sulfur.
